(19) United States
(12) Patent Application Publication
(10) Pub. No.: US 2004/0240720 A1
(43) Pub. Date: Dec. 2, 2004

(54) System and method for communicating abnormal medical findings

(76) Inventors: Steven D. Brantley, Marietta, GA (US); Bryan D. Brantley, Kennesaw, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/856,310

(22) Filed: May 28, 2004

Related U.S. Application Data
(60) Provisional application No. 60/474,171, filed on May 29, 2003.

(51) Int. Cl. G06K 9/36

(52) U.S. Cl. 382/132

(57) ABSTRACT

Systems and methods are provided for communicating abnormal or unexpected medical findings to a designated recipient, and documenting the succesful and correct communication to the recipient. One method includes: conducting a radiology examination of a patient and generating a machine radiology image; collecting information about the patient and designated recipient to permit correct communication to the recipient; an interpreter preparing an interpretation of the image, and applying a code to any interpretation classified as abnormal or unexpected; entering and storing in a computer the collected information for patients with an abnormal or unexpected code; a communicator accessing the collected information and communicating the abnormal or unexpected finding to a designated recipient; and entering and storing in a computer documentation of the successful and correct communication of the abnormal or unexpected interpretation.

### CROSS-REFERENCE TO RELATED APPLICATION

This application claims priority to copending U.S. provisional application entitled, “Process for Obtaining, Reporting and Storing Communication Documentation of Abnormal X-ray Exam Results from Information Systems,” having Serial No. 60/474,171, filed May 29, 2003, which is entirely incorporated herein by reference.

### FIELD OF THE INVENTION

The field of the invention is the reporting of abnormal or unusual medical findings from radiologic examinations and diagnostic tests to a designated recipient and documenting and storing the documentation in a computer for future reference.

### BACKGROUND

When a physician (e.g., radiologist) who interprets a radiologic image (e.g. X-ray, CAT scan, or MRI scan) finds an abnormal or unexpected result, medical standards require that he communicate this finding to the referring physician, healthcare provider, or other representative. A similar communication procedure is used by a physician who finds abnormal results in other diagnostic procedures, such a tissue biopsies or blood tests. It is important that the physician meet this standard of care, since failure to do so can result in medical malpractice liability. However, there are many obstacles that lie in the way of properly communicating abnormal results.

One communication method used by interpreting physicians is to mail the report indicating an abnormal or unexpected result to the referring physician. There are several problems with this method. The report itself could be lost in the mail. The address for the referring physician could be incorrect or out-of-date. Even if the report reaches to the referring physician's office, it may not come to the attention of the referring physician.

Instead of using the mail, the interpreting physician could call the referring physician to report the abnormal or unexpected result. But doctors are frequently difficult to reach on the phone. If the interpreting physician leaves a message requesting a return call, the interpreting physician might himself or herself be unreachable when the referring physician attempts to return the call. Leaving a voice mail is no guarantee that the physician actually receives the voice mail as it may never be opened or it may be opened by someone else in the physician's office and not conveyed to the physician.

Faxing the abnormal results to the referring physician is another alternative, but this has its own set of problems. Fax numbers are often busy for long periods of time, or out of paper. A received fax is easily misplaced in the physician's office, so that the doctor may never see the fax.

Finally, an interpreting physician who successfully contacts the referring physician can still be vulnerable to a malpractice claim. It is important that he have proof of a successful contact. Or, if the interpreting physician made a reasonable number of attempts to contact the referring physician but was ultimately unsuccessful, the interpreting physician should also have proof of this.

There is a need for a reporting system and method that solves these and other problems.

### SUMMARY

Systems and methods are provided for communicating abnormal or unexpected medical findings to a designated recipient, and documenting the successful and correct communication to the recipient. One method includes: conducting a radiology examination of a patient and generating a machine radiology image; collecting information about the patient and designated recipient to permit correct communication to the recipient; an interpreter preparing an interpretation of the image, and applying a code to any interpretation classified as abnormal or unexpected; entering and storing in a computer the collected information for patients with an abnormal or unexpected code; a communicator accessing the collected information and communicating the abnormal or unexpected finding to a designated recipient; and entering and storing in a computer documentation of the successful and correct communication of the abnormal or unexpected interpretation.

### DESCRIPTION OF THE DRAWINGS

FIG. 1 is a data flow diagram of the method for communicating abnormal radiological findings.

FIG. 2 illustrates an example of a general-purpose computer that can be used to implement an embodiment of the system for communicating abnormal medical findings.

FIG. 3 is another view of the system for communicating abnormal medical findings from FIG. 1, focusing on the data produced by the various steps rather than the actors.

FIG. 4 is a data flow diagram describing one embodiment of the system for communicating abnormal medical findings.

FIG. 5 is a data flow diagram of a method for communicating abnormal or unexpected medical findings.

### DETAILED DESCRIPTION

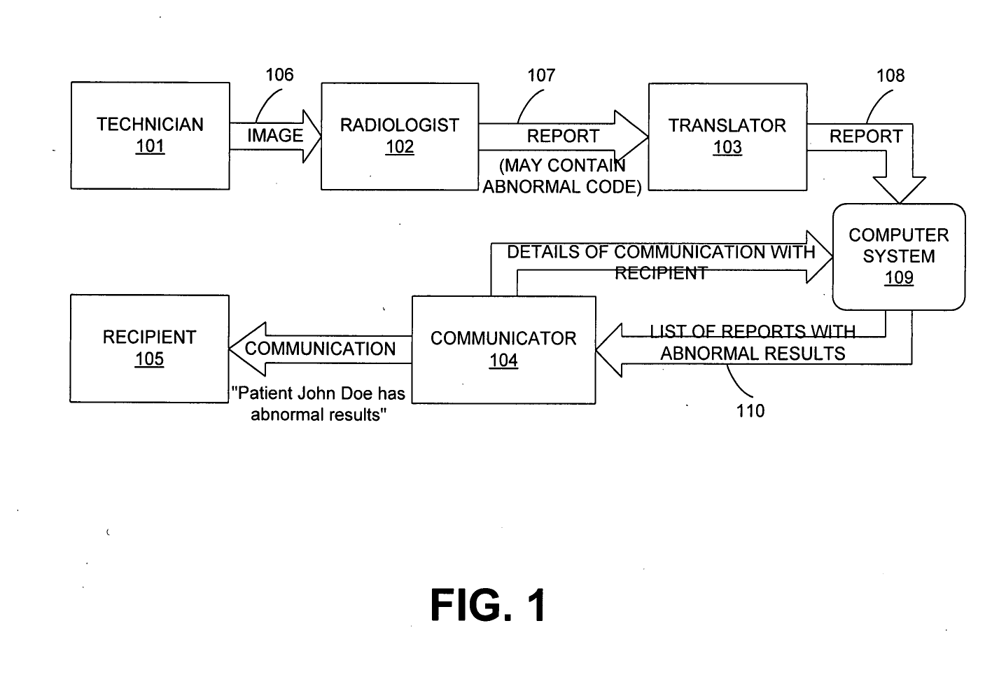

FIG. 1 is a data flow diagram of the method for communicating abnormal radiological findings. The actors are: technician 101; radiologist 102; translator 103; communicator 104; and recipient 105;

The technician 101 conducts a radiologic examination of a patient. The examination produces a machine-generated radiologic image of the patient. Many different radiologic modalities can be used to produce the image 106. Examples are X-ray, CT scan, MRI, fluoroscope, PET scans, mammograms, ultrasounds, nuclear medicine studies and interventional exams, but the invention is not limited to only these examples. The image 106 may take the form of a physical film, or it may be a digital image. This image 106 is provided to the radiologist 102, who is acting as the interpreting physician. The radiologist 102 examines the image 106, interprets the image 106, and produces a report 107 of his findings. The report 107 commonly takes the form of dictation, but the report may be prepared by other means, such as handwritten, entered into a computer, etc.

If the radiologist 102 classifies the findings as abnormal or unexpected, he or she also applies an “abnormal” code to the report 107, using a coding method appropriate to the report. In the case of a dictated report 107, the radiologist 102 might say a special keyword such as “Abnormal.” In the case of a computer-entered report, the radiologist 102 might check a field on the screen labeled “Abnormal.”

The translator 103 takes the report 107 as input and generates a report 108 as output. The report 108 is entered into the computer system 109. The translation process is specific to the reporting method. A report 107 which was directly entered by radiologist 102 into a computer system would require little if any translation. Translation for a dictated report 107 would be transcription into a report 108 residing on a computer system 109. The transcription process may involve humans, or may be done by voice recognition software.

Multiple reports 108 on a number of patients are thus generated and stored in a computer system 109. Some of these reports 108 contain the “abnormal” code indicating abnormal or unexpected findings. These abnormal findings will be communicated to the physician who referred the patient, or to another healthcare representative. The person receiving this communication is listed as the recipient 105.

The communicator 104 obtains from computer system 109 a list 110 of report contact records for all reports 108 with an abnormal code. Each report contact record contains sufficient information about the report 108 and about the recipient 105 to enable the communicator 104 to make contact with the recipient 105 and to report the fact that the patient's examination produced abnormal or unexpected results. In one embodiment, this information includes the name of the referring physician, his office telephone number, the patient name, and an identifier for the report 107. In one embodiment, the information in the report contact record information is manually entered into computer system 109. In another embodiment, the information is extracted from other records in computer system 109, as described in detail later.

Using the report contact records 302 on list 110, the communicator 104 contacts each recipient 105 and reports the abnormal or unexpected results. In a preferred embodiment, this list 110 contains only those recipients 105 who have not yet been successfully contacted by the communicator 104. In another preferred embodiment, this list 110 does not contain the full report 107, and therefore the complete findings in the report 108 are not communicated. In example, the report may only state that abnormal or unexpected results were obtained and the patient is advised to contact his or her referring physician immediately or as soon as convenient, depending on the circumstances. Patient privacy is thus maintained.

The communicator 104 documents a successful communication by entering into the computer system 109 a completed contact record containing details like the name of the party contacted, the time and date of the contact, the phone number where the party was reached, etc. In one embodiment, the computer system 109 stores any transmission verification report provided by the recipient's facsimile machine. In another embodiment, when a communicator 104 does not enter a completed contact record for a particular report contact record, the computer system 109 provides a reminder to the communicator 104 through an appropriate user interface mechanism such as a dialog box and a warning beep.

In one embodiment, the computer system 109 automatically contacts each recipient 105 and reports the abnormal or unexpected results via a facsimile transmission. In this embodiment, computer system 109 documents a successful communication by storing any transmission verification report provided by the recipient's facsimile machine.

Embodiments of the method and system for communicating abnormal medical findings described in as FIG. 1 can be implemented in software (e.g., firmware), hardware, or combinations thereof. Furthermore, the components of the system can reside on one computer system, or can be distributed among more than one computer system. In some embodiments, the system is implemented in software, as an executable program or programs, and is executed by a special or general-purpose digital computer, or combination of computers, such as a personal digital assistant or personal computer (PC).

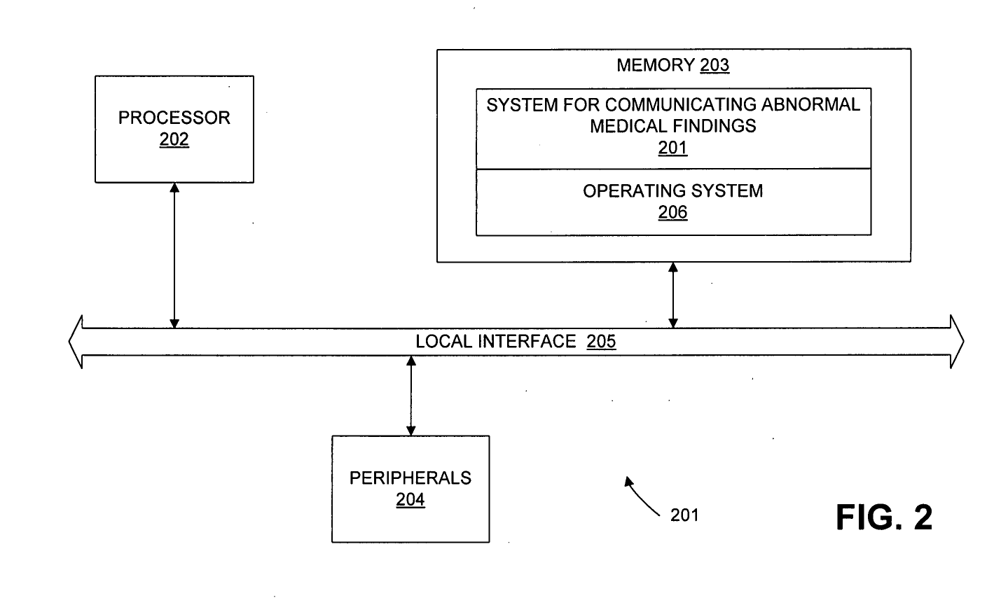

FIG. 2 illustrates an example of a general-purpose computer that can be used to implement an embodiment of the system for communicating abnormal medical findings. Generally, in terms of hardware architecture, as shown in FIG. 2 the computer 201 includes a processor 202, memory 203, and one or more input or output (I/O) devices or peripherals 204 that are communicatively coupled via a local interface 205. The local interface 205 can be, for example but not limited to, one or more buses or other wired or wireless connections, as is known in the art. The local interface 205 may have additional elements (omitted for simplicity), such as controllers, buffers, drivers, repeaters, and receivers, to enable communications. Further, the local interface 205 may include address, control, and data connections to enable appropriate communications among the aforementioned components.

The processor 202 is a hardware device for executing software, particularly that stored in memory 203. The processor 202 can be any custom made or commercially available processor, a central processing unit (CPU), an auxiliary processor among several processors associated with the computer 201, a semiconductor based microprocessor (in the form of a microchip or chip set), a microprocessor, or generally any device for executing software instructions.

The memory 203 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 203 may incorporate electronic, magnetic, optical, or other types of storage media. Note that the memory 203 can have a distributed architecture, where various components are situated remote from one another, but can be accessed by the processor 202.

The software in memory 203 may include one or more separate programs, each of which comprises an ordered listing of executable instructions for implementing logical functions. In the example of FIG. 2, the software in the memory 203 includes one or more components of the system for communicating abnormal medical findings, and a suitable operating system 206. The operating system 206 essentially controls the execution of other computer programs, such as the system for communicating abnormal medical findings, and provides scheduling, input-output control, file and data management, memory management, and communication control and related services.

The system for communicating abnormal medical findings is a source program, executable program (object code), script, or any other entity comprising a set of instructions to be performed. When a source program, then the program needs to be translated via a compiler, assembler, interpreter, or the like, which may or may not be included within memory 203, so as to operate properly in connection with the operating system 206.

The peripherals 204 may include input devices, for example but not limited to, a keyboard, mouse, scanner, microphone, etc. Furthermore, the peripherals 204 may also include output devices, for example but not limited to, a printer, display, facsimile device, etc. Finally, the peripherals 204 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 201 is a PC, workstation, or the like, the software in the memory 203 may further include a basic input output system (BIOS). The BIOS is a set of essential software routines that initialize and test hardware at startup, start the operating system 206, and support the transfer of data among the hardware devices. The BIOS is stored in the ROM so that the BIOS can be executed when the computer 201 is activated.

When the computer 201 is in operation, the processor 202 is configured to execute software stored within the memory 203, to communicate data to and from the memory 203, and to generally control operations of the computer 201 pursuant to the software. The system for communicating abnormal medical findings and the operating system 206, in whole or in part, but typically the latter, are read by the processor 202, and perhaps buffered within the processor 202, and then executed.

When the system for communicating abnormal medical findings is implemented in software, as is shown in FIG. 2, it should be noted that the system for communicating abnormal medical findings can be stored on any computer readable medium for use by or in connection with any computer related system or method. In the context of this document, a “computer-readable medium” can be any means that can store, communicate, propagate, or transport the program for use by or in connection with the instruction execution system, system, or device. The computer-readable medium can be, for example but not limited to, an electronic, magnetic, optical, electromagnetic, infrared, or semiconductor system, system, device, or propagation medium. A non-exhaustive example set of the computer-readable medium would include the following: an electrical connection having one or more wires, a portable computer diskette, a random access memory (RAM), a read-only memory (ROM), an erasable programmable read-only memory (EPROM, EEPROM, or Flash memory), and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system for communicating abnormal medical findings is implemented in hardware, the system for communicating abnormal medical findings can be implemented with any or a combination of the following technologies, which are each well known in the art: a discrete logic circuit(s) having logic gates for implementing logic functions upon data signals, an application specific integrated circuit(s) (ASIC) having appropriate combinatorial logic gates, a programmable gate array(s) (PGA), a field programmable gate array(s) (FPGA), etc.

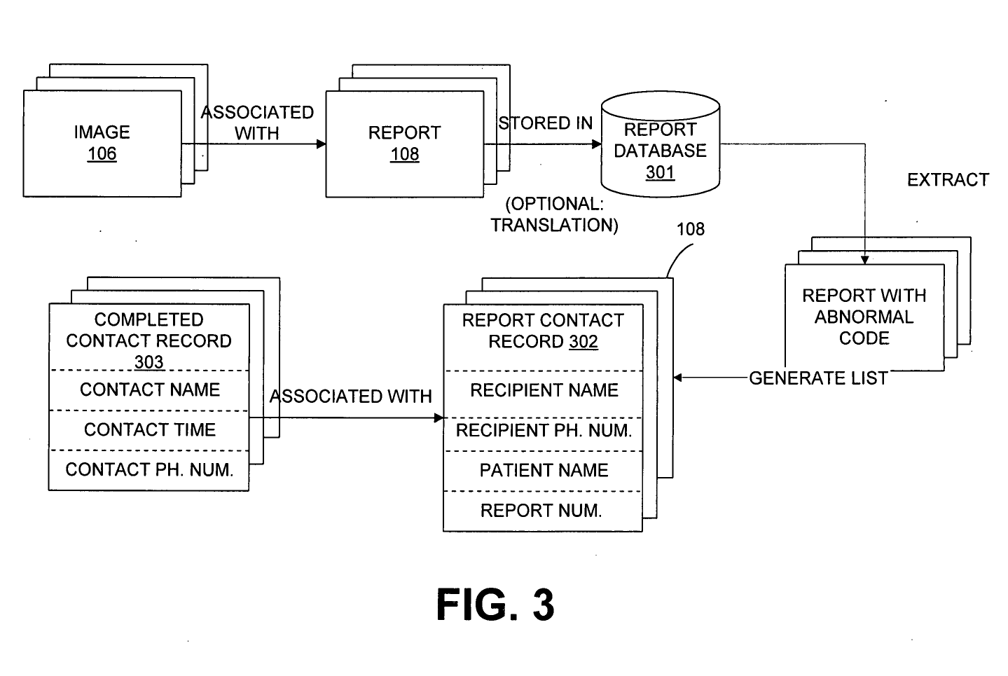

FIG. 3 is another view of the system for communicating abnormal medical findings from FIG. 1, focusing on the data produced by the various steps rather than the actors. Radiologic images 106 of a patient are generated by a technician 101. The radiologist 102 interprets each image 106 and produces a report 108, which may include an abnormal result code. Multiple reports 108 for multiple patients are stored in a radiology report database 301. In this example, the translation described in connection with FIG. 1 is shown as optional. Reports 108 with an abnormal code are extracted from radiology report database 301, and a list 110 of report contact records 302 is produced using the extracted abnormal reports.

Each report contact record 302 in the list 110 contains contact information for a recipient 105, such as office telephone number, office fax number, office mailing address, emergency phone number, etc. In one embodiment, reports 108 contain this contact information, so that report contact records 302 are derived from radiology report database 301. In another embodiment, report contact records 302 are stored in a separate database table. The two databases or tables are linked by a recipient identifier, which is common to both. The identifier may be a physician's name, identification number, or any other unique identifier. The recipient may be the patient or a designated representative.

A separate table for report contact records 302 is especially advantageous when the radiology report database 301 is maintained by an entity such as a hospital which is not the entity using the system to report results. In this case, the radiology report database 301 is likely to contain out-of-date contact information. In this embodiment, the system also provides a mechanism for updating the report contact records 302.

On completion of a successful communication, a completed contact record 303 is generated, usually by the communicator 104. The completed contact record 303 may contain details, such as the name of the party contacted, the time and date of the contact, the phone number where the party was reached, etc. Note that the name of the party contacted and the phone number are not necessarily the same as the recipient's name. While the recipient is usually the referring physician, the party contacted is often a nurse or receptionist. Similarly, there may be multiple contact phone numbers that are attempted, and a party is reached at one or more of these numbers.

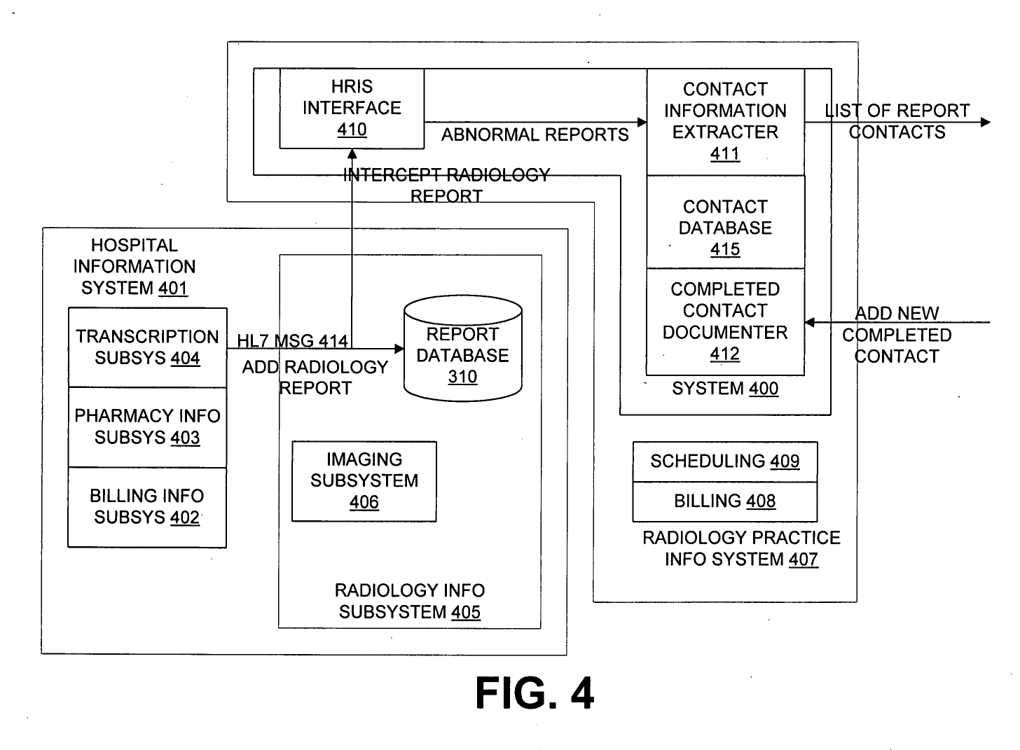

FIG. 4 is a data flow diagram describing one embodiment of the system for communicating abnormal medical findings 400 where the entity which maintains the radiology report database 301 is different than the entity that communicates the abnormal or unusual results. The hospital information system 401 is a collection of various computer system components residing in a hospital. The hospital information system 401 is divided into subsystems, such as billing 402, pharmacy 403, medical records transcription 404, radiology 405, etc. In this embodiment, the transcription subsystem 404 produces radiology reports 108, which are added to the radiology report database 301. The radiology report database 301 is part of the radiology information subsystem 405. This subsystem also includes imaging subsystem 406, the component that generates and stores the radiologic images 106 that are associated with reports 108.

In one embodiment, one or more of these subsystems uses the Health Level 7 (HL7) set of standards to communicate with each other. HL7 is a set of standards for exchanging healthcare information, such as patient registration, patient insurance, appointment scheduling, and clinical reports and results (e.g., laboratory, pharmacy, radiology, and other diagnostic services). HL7 specifies the format, structure, and sequence of that data between information providers and information clients. HL7 messages are based on activities in the healthcare arena, such as “admit a patient,”“order an x-ray,” and “report an x-ray result.” Messages are built of segments (e.g., header, patient id, order info, and result info), and segments are built of fields (e.g., sending application, patient name, ordering provider). The syntax of HL7 messages is based on Extensible Markup Language (XML), which is a metalanguage for defining other languages. HL7 will be well understood by one skilled in the art of healthcare information systems.

The radiologist 102 (FIG. 1) who interprets images 106 to produce reports 108 is associated with hospital, but is not usually employed by that hospital. Typically, the radiologist 102 organizes with other radiologists into a practice group. Because the practice group is separate from the hospital, it has its own radiology practice information system 407, which consists of various components for patient billing 408, scheduling of appointments 409, etc.

When a report 108 for a particular patient contains an abnormal or unexpected finding, it is the responsibility of the radiologist 102, rather than the hospital, to report the abnormal findings. The abnormal findings should be communicated to the physician who referred the patient to the radiologist, or to another healthcare representative whom the patient has designated.

To enable the reporting of these findings, the radiology information subsystem 405 also contains the system for communicating abnormal medical findings 400. The system logically consists of several components or modules, including a hospital radiology IS interface (HRIS) 410, a contact information extracter 411, and a completed contact documenter 412. These three components are logically part of the radiology information subsystem 405, but their physical locations may vary.

In a preferred embodiment, the contact extracter 411 and completed contact documenter 412 are physically located at the practice group office with the other components of the system for communicating abnormal medical findings 400, and HRIS interface 410 is physically located at the hospital. HRIS interface 410 communicates with the contact extracter 411 and completed contact documenter 412 through any mechanism which allows remote communications between computer components, such as a wide area network, a modem, etc.

As explained in connection with previous figures, the system for communicating abnormal medical findings extracts reports 108 that contain abnormal results, and generates a list 110 of report contact records 302 containing contact information associated with the abnormal reports. In this embodiment, the hospital information system 401 and the radiology practice information system 407 are separate, so that the system for communicating abnormal medical findings does not have direct access to radiology report database 301 containing the reports 108. HRIS interface 410 provides the interface between the two systems.

In a preferred embodiment, HRIS interface 410 intercepts HL7 messages 413 indicating that reports 108 are being added to radiology report database 301. HRIS interface 410 is capable of intercepting HL7 messages directed to radiology report database 301, and of parsing the messages to determine which are of interest and should be further processed. For example, HRIS interface 410 sees report messages for all radiologists, but only reports those associated with a specific set of radiologists (those in the practice group that is operating the system 400) that need further processing. All others are filtered out. Additional filters may be used, for example, to include or exclude reports based on dates or date ranges, or to include or exclude based on a specific radiologist within the group. Finally, only report messages indicating an abnormal result are reported.

When a report message of interest has been identified, the system for communicating abnormal medical findings extracts contact information from the report message to produce a report contact record 302. In the embodiment of FIG. 4, this functionality is performed by contact extracter 411, but this functionality could reside instead in HRIS interface 410. If report message contains an identifier for the referring physician but does not contain sufficient contact information (e.g., no phone number), then contact extracter 411 utilizes the contact database 414 to determine additional contact information based on the identifier.

The report contact records 302 produced by contact extracter 411 are provided as output and used by communicator 104 to contact a particular recipient and to report the abnormal result to that recipient. The communicator 104 then interacts with completed contact documenter 412 to record the details of a successful contact into a completed contact record 303.

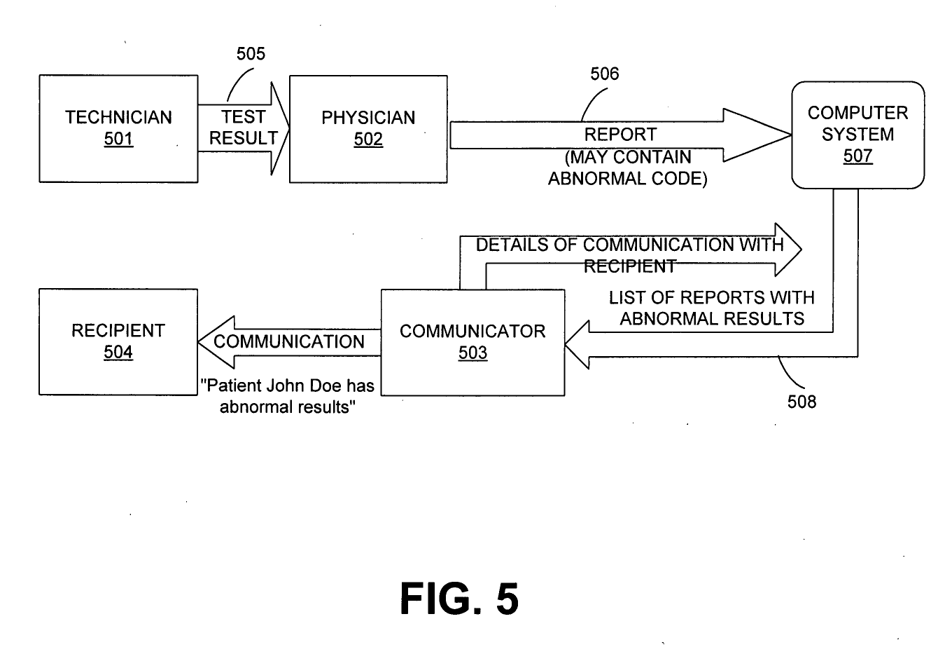

FIG. 5 is a data flow diagram of a method for communicating abnormal or unexpected medical findings. This method is similar to the method of FIG. 1, but is used communicate abnormal results for medical tests rather than radiology reports. Tests may include: blood tests such as pregnancy and HIV; tissue cultures such as pap smears, biopsies, throat cultures, etc. The actors are: technician 501; physician 502; communicator 503; and recipient 504;

The technician 501 performs a medical test on a patient, which involves taking a sample and producing a result 505. This result 505 is provided to the interpreting physician 502, who produces a report 506 of his or her findings. The report 506 commonly takes the form of dictation, but that report may be prepared by other means, such as handwritten, entered into a computer, etc.

If the physician 502 classifies the findings as abnormal or unexpected, he or she also applies an “abnormal” code to the report 506, using a coding method appropriate to the report. In the case of a dictated report 506, the physician 502 might say a special keyword such as “Abnormal.” In the case of a computer-entered report, the physician 502 might check a field on the screen labeled “Abnormal.” The Report 506 may optionally undergo translation, such as from a dictated report to a report entered into the computer system 507.

Multiple reports 506 are thus generated and stored in computer system 507. Some of these reports 505 contain the “abnormal” code indicating abnormal findings. These abnormal findings will be communicated to the physician who referred the patient, or to another healthcare representative. The person receiving this communication is the recipient 504.

The communicator 503 obtains from computer system 507 a list 508 of report contact records for all reports 506 with an abnormal code. Each report contact record contains sufficient information about the report 506 and about the recipient 504 to enable the communicator 503 to make contact with the recipient 504 and to report the fact that the patient has abnormal results. In one embodiment, this information includes the name of the referring physician, his office telephone number, the patient name, and an identifier for the report 506. In another embodiment, the information in the report contact record is manually entered into computer system 507. In another embodiment, the information is extracted from other records in computer system 507, as described in detail later.

Using the report contact records on list 508, communicator 503 contacts each recipient 504 and reports the abnormal results. In a preferred embodiment, this list 508 contains only those recipients who have not yet been successfully contacted by communicator 503. In a preferred embodiment, list 508 does not contain the full report 506, and therefore the complete findings in the report 506 are not communicated. Patient privacy is thus maintained.

The communicator 503 documents a successful communication by entering, into the computer system 507, a completed contact record containing details like the name of the party contacted, the time and date of the contact, the phone number where the party was reached, etc.

The foregoing description has been presented for purposes of illustration and description. It is not intended to be exhaustive or to limit the invention to the precise forms disclosed. Obvious modifications or variations are possible in light of the above teachings. The embodiments discussed, however, were chosen and described to illustrate the principles of the invention and its practical application to thereby enable one of ordinary skill in the art to utilize the invention in various embodiments and with various modifications are suited as to the particular use contemplated. All such modifications and variation are within the scope of the invention as determined by the appended claims when interpreted in accordance with the breadth to which they are fairly and legally entitled.

Therefore, having thus described the invention, at least the following is claimed:

1. A process for communicating an abnormal or unexpected finding by an interpreter of a machine generated radiology modality of a patient to a designated recipient and documenting the successful and correct communication to the recipient comprising:
(a) conducting a radiology examination of a patient and generating a machine radiology image;
(b) collecting sufficient information about the patient and designated recipient to permit correct communication to the recipient of any abnormal or unexpected finding that may be made on the examination as to the patient;
(c) an interpreter examining the radiology image of the patient and preparing an interpretation of the image and applying a code to any interpretation the interpreter classifies as abnormal or unexpected;
(d) entering and storing in a computer the information collected about the designated recipient and patient whose interpretation receives the code;
(e) a communicator accessing the collected information of a recipient and patient with the code in the computer and communicating the abnormal or unexpected finding as to the patient to a designated recipient for receiving any such finding; and
(f) entering and storing in a computer the documentation of the successful and correct communication of the abnormal or unexpected interpretation of the radiology image of a patient to the designated recipient.

2. The process of claim 1 in which the interpreter in step (c) dictates his or her interpretation of the radiology modality of a patient and applies a code if the interpreter classifies the interpretation as abnormal or unexpected and the dictation is transcribed by a person and certain information about the recipient and the patient including any code is entered into the computer in step (d).

3. The process of claim 1 in which the interpreter in step (c) dictates his or her interpretation of the radiology modality of a patient and applies a code if the interpreter classifies the interpretation as abnormal or unexpected and the dictation is transcribed by a voice recognition system and certain information about the recipient and the patient including any code is entered into the computer in step (d).

4. The process of claim 1 in which the computer stores all of the information about a designated recipient and patient, but the computer is programmed to provide, to the communicator, only information which has not yet been successfully communicated to the designated recipient.

5. The process of claim 1 in which the computer is programmed to find selected coded interpretations of the images of patients and display them as ordered by the communicator.

6. The process of claim 2 in which the interpreter reviews the transcription of any code in the dictation and approves any code as to a patient prior to communication by the communicator to the designated recipient.

7. The process of claim 2 in which the interpreter reviews any code in the transcription by the voice recognition system and approves any code as to a patient prior to communication to the designated recipient.

8. The process of claim 1 in which the abnormal or unexpected findings as to a patient are communicated by facsimile to a designated recipient by the computer and the facsimile and any verification of a successful transmission is stored in the computer.

9. The process of claim 1 in which any unsuccessful transmission attempt is automatically called to the attention of the communicator by the computer.

10. A process for communicating an abnormal or unexpected finding by an interpreter of a medical test of a patient to a designated recipient and documenting the successful and correct communication to the recipient comprising:
(a) conducting a medical test of a patient and generating a result;
(b) collecting sufficient information about the patient and designated recipient to permit correct communication to the recipient of any abnormal or unexpected finding that may be made on the result as to the patient;
(c) an interpreter examining the result of the patient and preparing an interpretation of the result and applying a code to any interpretation the interpreter classifies as an abnormal or unexpected result;
(d) entering and storing in a computer the information collected about the designated recipient and patient whose interpretation receives the code;
(e) a communicator accessing the collected information of a recipient and patient with the code in the computer and communicating the abnormal or unexpected finding as to the patient to a designated recipient for receiving any such finding; and
(f) entering and storing in a computer the documentation of the successful and correct communication of the abnormal or unexpected interpretation of the radiology modality of a patient to the designated recipient.

11. The process of claim 10 in which the interpreter in step (c) dictates his or her interpretation of the result of a patient and applies a code if the interpreter classifies the interpretation as abnormal or unexpected and the dictation is transcribed by a person and certain information about the recipient and the patient including any code is entered into the computer in step (d).

12. The process of claim 10 in which the interpreter in step (c) dictates his or her interpretation of the result of a patient and applies a code if the interpreter classifies the interpretation as abnormal or unexpected and the dictation is transcribed by a voice recognition system and certain information about the recipient and the patient including any code is entered into the computer in step (d).

13. The process of claim 10 in which the computer stores all of the information about a designated recipient and patient, but the computer is programmed to provide, to the communicator, only information which has not yet been successfully communicated to the designated recipient.

14. The process of claim 10 in which the computer is programmed to find selected coded interpretations of the images of patients and display them as ordered by the communicator.

15. The process of claim 11 in which the interpreter reviews the transcription of any code in the dictation and approves any code as to a patient prior to communication by the communicator to the designated recipient.

16. The process of claim 11 in which the interpreter reviews any code in the transcription by the voice recognition system and approves any code as to a patient prior to communication to the designated recipient.

17. The process of claim 10 in which the abnormal or unexpected findings as to a patient are communicated by facsimile to a designated recipient by the computer and the facsimile and any verification of a successful transmission is stored in the computer.

18. The process of claim 10 in which any unsuccessful transmission attempt is automatically called to the attention of the communicator by the computer.

19. A system for communicating an abnormal or unexpected finding by an interpreter of a medical test of a patient to a designated recipient and documenting the successful and correct communication to the recipient, the system comprising:
a memory to store one or more programs, where each program comprises executable instructions;
a processor in communication with the memory through a local interface for executing instructions from the one or more programs stored in memory;
logic configured to receive a first set of radiologic report records, each radiologic report record representing a radiologic report associated with at least one radiologic image of a patient;
logic configured to extract a second set of radiologic report records from the first set of radiology report records, each record in the second set having an abnormal result code;
logic configured to generate a list of report contact records corresponding to the second set of report records, each report contact record identifying at least one recipient to be contacted about one of the radiology reports in the second set; and
logic configured to generate a set of completed contact records, each completed contact record associated with one of the report contact records, each completed contact record comprising a contact name and a contact time and date.

20. The system of claim 19, wherein the report contact record comprises recipient name, a recipient telephone number, a patient name, and a report identifier.

21. The system of claim 19, wherein the recipient is a referring physician associated with the patient.

22. The system of claim 19, further comprising:
logic configured to extract the recipient identifier from the second set of report records.

23. The system of claim 21, further comprising:
logic configured to extract the recipient contact number from a recipient contact database using the recipient identifier.

24. The system of claim 23, further comprising:
logic configured to receive a set of recipient contact records into the recipient contact database.

25. A computer readable medium containing a program for communicating an abnormal or unexpected finding by an interpreter of a medical test of a patient to a designated recipient and documenting the successful and correct communication to the recipient, the program comprising the steps of:
receiving a first set of radiologic report records, each radiologic report record representing a radiologic report associated with a radiologic image of a patient;
extracting a second set of radiologic report records from the first set of radiology report records, each record in the second set having an abnormal result code;
generating a list of report contact records corresponding to the second set of report records, each report contact record identifying a recipient to be contacted about one of the radiology reports in the second set; and
generating a set of completed contact records, each completed contact record associated with one of the report contact records, each completed contact record comprising a contact name and a contact time and date.

26. The computer readable medium of claim 25, wherein the report contact record comprises a recipient name, a recipient telephone number, a patient name, and a report identifier.

27. The computer readable medium of claim 25, wherein the recipient is a referring physician associated with the patient.

28. The computer readable medium of claim 25, wherein the program further comprises the step of:
extracting the recipient identifier from the second set of report records.

29. The computer readable medium of claim 25, wherein the program further comprises the step of:
extracting the recipient contact number from a recipient contact database using the recipient identifier.

30. The computer readable medium of claim 25, wherein the program further comprises the step of:
receiving a set of recipient contact records into the recipient contact database.

31. A method for communicating an abnormal or unexpected finding by an interpreter of a medical test of a patient to a designated recipient and documenting the successful and correct communication to the recipient, the method comprising:
receiving a first set of medical report records, each medical report record representing a medical report associated with a medical test of a patient;
extracting a second set of medical report records from the first set of medical report records, each record in the second set having an abnormal result code;
generating a list of report contact records corresponding to the second set of report records, each report contact record identifying a recipient to be contacted about one of the medical reports in the second set; and
generating a set of completed contact records, each completed contact record associated with one of the report contact records, each completed contact record comprising a contact name and a contact time and date.

32. The method of claim 31, wherein the report contact record comprises a recipient name, a recipient telephone number, a patient name, and a report identifier.

33. The method of claim 31, wherein the recipient is a referring physician associated with the patient.

34. The method of claim 31, further comprising:
extracting the recipient identifier from the second set of report records.

35. The method of claim 31, further comprising:
extracting the recipient contact number from a recipient contact database using the recipient identifier.

36. The method of claim 35, further comprising:
receiving a set of recipient contact records into the recipient contact database.

37. A system for communicating an abnormal finding by an interpreter of a medical test of a patient to a designated recipient and documenting the successful and correct communication to the recipient, the system comprising:
a memory to store one or more programs, where programs comprise executable instructions;
a processor in communication with the memory through a local interface for executing instructions from the one or more programs stored in memory;
logic configured to intercept a first set of medical report result messages, each message indicating a result associated with a medical test of a patient, each message using the HL7 format;
logic configured to extract a second set of medical report result messages from the first set of medical report result mesages, each message in the second set having an abnormal result code;
logic configured to generate a list of report contact records corresponding to the second set of result messages, each report contact record identifying a recipient to be contacted about one of the medical reports in the second set; and
logic configured to generate a set of completed contact records, each completed contact record associated with one of the report contact records, each completed contact record comprising a contact name and a contact time and date.

38. The system of claim 37, further comprising:
logic configured to receive a physician identifier;
logic configured to parse the first set of medical report result messages to produce a first indication of a physician who ordered the image; and
logic configured to filter out, from the first set of medical report results messages, messages with first indications where the physician is not equivalent to the received physician identifier.

39. The system of claim 37, further comprising:
logic configured to receive a date range;
logic configured to parse the first set of medical report result messages to produce a second indication of a date the image was ordered; and
logic configured to filter out, from the first set of medical report results messages, messages with second indications where the date is not within the received date range.

40. The system of claim 37, wherein the medical report result messages are directed to a radiology information system located in a hospital.

41. The system of claim 37, wherein the logic configured to intercept is located at the hospital.
